(19) United States
(12) Patent Application Publication
(10) Pub. No.: US 2004/0234856 A1
(43) Pub. Date: Nov. 25, 2004

(54) Lithium ion secondary battery

(75) Inventors: Kenichi Morigaki, Nishinomiya-shi (JP); Shuji Tsutsumi, Osaka (JP)

Correspondence Address: MCDERMOTT, WILL & EMERY, 600 13th Street, N.W., WASHINGTON, DC, 20005-3096, US

(73) Assignee: MATSUSHITA ELECTRIC INDUSTRIAL CO., LTD.

(21) Appl. No.: 10/849,043

(22) Filed: May 20, 2004

(30) Foreign Application Priority Data
May 22, 2003 (JP) JP2003-144677

(51) Int. Cl. H01M 4/48; H01M 4/62

(52) U.S. Cl. 429/231.1; 429/232

(57) ABSTRACT

In the case of using a thick electrode plate with a high packing density of an active material, a lithium-containing oxide Y not involved in charge/discharge reaction is added to a negative electrode to improve the transport of lithium ions from an active material to the surface of the electrode plate. The lithium-containing oxide Y has a mean particle size of 0.01 to 0.5 μm.

### BACKGROUND OF THE INVENTION

The present invention relates to a lithium ion secondary battery comprising: a positive electrode containing a positive electrode active material composed of a lithium-containing composite oxide; a negative electrode containing a negative electrode active material composed of a material capable of absorbing and desorbing lithium ions; an organic electrolyte; and a separator.

Lithium ion secondary batteries employing an organic electrolyte, a negative electrode active material composed of a carbonaceous material and a positive electrode active material composed of a lithium-containing composite oxide such as LiCoO₂ have a voltage and energy density higher than secondary batteries employing an aqueous electrolyte. For this reason, lithium ion secondary batteries are rapidly becoming commercially available as the main power source for mobile devices and the like.

At the same time, demand has been increasing for lithium ion secondary batteries having a larger capacity and a higher energy density as mobile devices provide higher performance and various functions.

In currently available lithium ion secondary batteries, however, both positive and negative electrode active materials have already achieved a utilization rate of approximately 100%. Further improvement of energy density requires an increase in the amount of the active materials to be filled in the battery having a given capacity by replacing the active materials with other materials having a higher capacity or by increasing the packing density of the active materials in the electrode plates as well as the thickness of the electrode plates.

In the case of replacing the active materials with other materials having a higher capacity, the design of the circuit of a device that utilizes the battery has to be changed because the discharge characteristics of the battery varies. Accordingly, a battery employing active materials composed of a material having a higher capacity cannot be used in a conventional device. It is therefore desirable to achieve a battery with a higher energy density by increasing the packing density of the active materials in the positive and negative electrodes and the thickness of the electrode plates, or by reducing the volume ratio of elements that have nothing to do with the battery capacity such as a current collector and a separator.

Excessive increase in the packing density of the active materials or in the thickness of the electrode plates, however, significantly reduces charge/discharge characteristics, particularly high rate charge/discharge characteristics. The reason is as follows. If the porosity of the electrode plates is reduced by the improvement of the packing density or the thickness thereof is increased, the electrolyte will not be able to rapidly transport lithium ions. Moreover, the electrolyte has an increased viscosity at a low temperature so that the charge/discharge characteristics of the electrode plates significantly lower. This may reduce the utilization rate of both positive and negative electrode active materials down to 20 to 30%, and eventually the practical energy density.

It is thus crucial to improve the characteristics of the electrode plates. In order to improve cycle characteristics, for example, Japanese Laid-Open Patent Publication No. Hei 7-153495 proposes to add, to a positive electrode, an additive not directly involved in charge/discharge reaction such as an oxide, namely, Al₂O₃, In₂O₃, SnO₂ or ZnO.

Further, Japanese Laid-Open Patent Publications Nos. Hei 10-188957 and Hei 11-73969 propose to add an inorganic porous particle to a negative electrode containing a negative electrode active material made of a carbonaceous material.

In order to improve high rate discharge characteristics, Japanese Laid-Open Patent Publication No. 10-255807 proposes to add ceramic such as Al₂O₃, SiO₂, ZrO₂, MgO or Na₂O to a negative electrode containing a negative electrode active material made of a carbonaceous material.

Even when such electrode plates containing the additive are used, charge/discharge characteristics, particularly high rate characteristics and low temperature characteristics will be significantly impaired, if the packing density and the thickness of the electrode plates are increased to improve energy density. This is because a decrease in the porosity of the electrode plates retards the impregnation of an electrolyte, and transport rate of lithium ions becomes slow and thus the active material in the electrode plates cannot be effectively involved in charge/discharge reaction.

In order to improve the impregnation of an electrolyte, a possible way is to increase the porosity of the electrode plates. However, increased porosity of the electrode plates will reduce the mechanical strength of the electrode plates, causing the separation or detachment of the material mixture layer of the electrode plates. On the other hand, if the ratio of the binder contained in the electrode plates is increased for the purpose of improving the mechanical strength of the electrode plates, electrode plates will not have a high energy density.

In view of the above, the object of the present invention is to provide a lithium ion secondary battery having a high energy density as well as excellent cycle characteristics.

### BRIEF SUMMARY OF THE INVENTION

The present invention relates to a lithium ion secondary battery comprising: (1) a positive electrode containing a positive electrode active material composed of a lithium-containing composite oxide X; (2) a negative electrode containing a negative electrode active material composed of a material capable of absorbing and desorbing lithium ions and a lithium-containing oxide Y not involved in charge/discharge reaction; (3) an organic electrolyte; and (4) a separator placed between the positive electrode and the negative electrode, wherein the lithium-containing composite oxide X and the lithium-containing oxide Y are different materials and the lithium-containing oxide Y has a mean particle size of 0.01 to 0.5 μm.

In the aforesaid lithium ion secondary battery, the lithium-containing oxide Y is preferably contained in the negative electrode in an amount of 0.01 to 1 part by weight relative to 100 parts by weight of the negative electrode active material.

In the aforesaid lithium ion secondary battery, when the negative electrode comprises a current collector and a material mixture layer formed on the current collector, the thickness of the negative electrode material mixture layer is preferably in the range of 0.03 to 0.29 mm. The “thickness of the negative electrode material mixture layer” used herein means a thickness of the material mixture layer formed on one surface of the electrode plate.

In the aforesaid lithium ion secondary battery, the lithium-containing oxide Y preferably comprises at least one selected from the group consisting of LiAlO₂, Li₂TiO₃, Li₂ZrO₃, LiTaO₃, LiNbO₃, LiVO₃, Li₂SiO₃ and Li₄SiO₄.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical cross sectional view of a lithium ion secondary battery according to one embodiment of the present invention.

### DETAILED DESCRIPTION OF THE INVENTION

One embodiment of the present invention is described below with reference to the accompanying drawing.

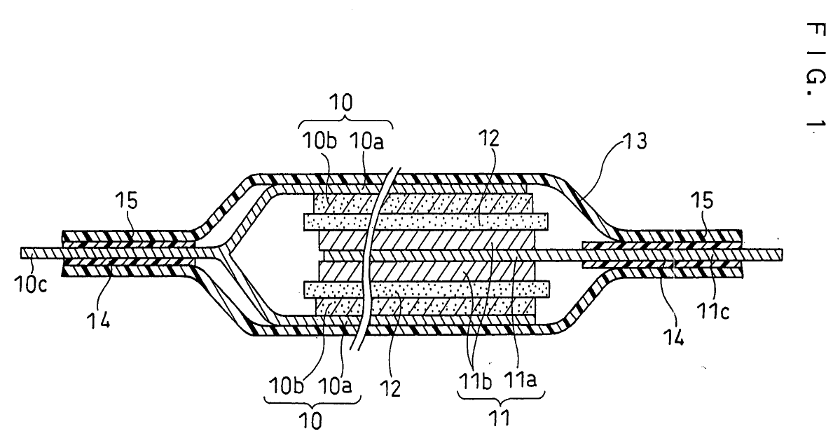

FIG. 1 shows a vertical cross sectional view of a lithium ion secondary battery according to one embodiment of the present invention.

The lithium ion secondary battery in FIG. 1 comprises a pair of positive electrodes 10, a negative electrode 11, a pair of separators 12, an outer jacket 13, an insulating material 14 and an organic electrolyte (not shown in the figure).

As shown in FIG. 1, the positive electrode 10 comprises a positive electrode current collector 10a and a positive electrode material mixture 10b formed on the underside of the positive electrode current collector 10a. The negative electrode 11 comprises a negative electrode current collector 11a and negative electrode material mixture layers 11b formed on both surfaces of the negative electrode current collector 11a. The negative electrode 11 is sandwiched between two positive electrodes 10 with the separators 12 interposed therebetween. An electrode assembly structured like this is housed in the outer jacket 13. An end 11c formed by combining the ends of the positive electrode current collectors 10a with no material mixture layer formed thereon and an end 11c of the negative electrode current collector 11a with no material mixture layer formed thereon are respectively drawn to the outside through openings 15 of the outer jacket 13. The insulating material 14 is placed between the end 10c and the opening 15 of the outer jacket 13 and between the end 11c and the other opening 15 thereof. The insulating material 14 serves to attach the ends of the current collectors, namely, the ends 10c and 11c, to the openings 15 as well as to seal the inside of the battery.

The positive electrode material mixture layer 10b comprises an active material composed of a lithium-containing composite oxide X (hereinafter may be referred to as “oxide X”), a conductive material and a binder.

The negative electrode material mixture layer 11b comprises an active material composed of a material capable of absorbing and desorbing lithium ions, a binder and a lithium-containing oxide Y not involved in charge/discharge reaction (hereinafter may be referred to as “oxide Y”). The lithium-containing oxide Y has a mean particle size of 0.01 to 0.5 μm. The lithium-containing oxide Y and the oxide X which is an active material for positive electrode are different materials.

The oxide X serving as the positive electrode active material may be any lithium-containing composite oxide known in the pertinent art. Examples thereof include LiCoO₂, LiNiO₂, Li₂MnO₄, LiMnO₂, LiV₃O₈. They may be used singly or in any combination thereof.

The negative electrode active material for use may be any material capable of absorbing and desorbing lithium ions known in the pertinent art. Examples of the material capable of absorbing and desorbing lithium ions include carbonaceous materials such as artificial graphite, natural graphite and graphitized carbon fiber, Si, Sn, Al, B, Ge, P, Pb, any mixed alloy thereof and oxides thereof, and nitrides such as Li₃N and Li₃₋ₓCoₓN.

As the conductive material contained in the positive electrode material mixture layer, there can be used, for example, acetylene black.

The binder contained in the positive and negative electrode material mixture layers may be any material stable in an organic electrolyte. Examples thereof include styrene butadiene resin and polyvinylidene fluoride resin.

In the positive electrode material mixture layer, the amount of the conductive material is preferably 1 to 10 parts by weight relative to 100 parts by weight of the active material. The amount of the binder is preferably 1 to 10 parts by weight relative to 100 parts by weight of the active material.

In the negative electrode material mixture layer, the amount of the binder is preferably 1 to 10 parts by weight relative to 100 parts by weight of the active material.

The separator may be made of any thin microporous material with a high mechanical strength. One example thereof is a porous separator made of polyolefin resin. A lithium ion conductive gel comprising a polymer matrix and an electrolyte impregnated therein can also be used as the separator.

The outer jacket may be any material known in the pertinent art. Examples include a laminated sheet obtained by laminating an aluminum foil and a thermoplastic resin, and an aluminum can.

As the positive electrode current collector, a sheet or foil made of, for example, stainless steel, aluminum or titanium can be used. As the negative electrode current collector, a sheet or foil made of, for example, stainless steel, nickel or copper can be used. The thickness thereof is usually 10 to 30 μm.

As the organic electrolyte, any combination of a solute and an organic solvent typically used in lithium ion secondary batteries can be selected. For example, an electrolyte prepared by dissolving a lithium salt in a mixture solvent of a cyclic carbonic acid ester and a non-cyclic carbonic acid ester can be used. One specific example thereof is an electrolyte prepared by dissolving lithium hexafluorophosphate (LiPF₆) as the solute in a mixture solvent of ethylene carbonate (EC), diethyl carbonate (DEC) and ethyl methyl carbonate (EMC).

The positive electrode current collector may have positive electrode material mixture layers formed on both surfaces thereof. In this case, a plurality of the positive electrodes 10 and a plurality of the negative electrodes 11 can be laminated with the separators interposed therebetween.

The electrode assembly comprising the positive electrode 10, the negative electrode 11 and the separator 12 may be directly housed into the outer jacket, or may be spirally wound and then housed into the outer jacket.

The oxide Y to be added in the negative electrode material mixture layer is now described.

The lithium-containing oxide Y to be added to the negative electrode material mixture layer has a high affinity for lithium ions. Accordingly, lithium ions are selectively transported at the surface of the oxide Y or the interface between the electrolyte and the oxide Y, other than the ordinary transport thereof by the electrolyte within the electrode plate. For this reason, even in the thick electrode plate with a high packing density of the active material, it is possible to improve the transport of lithium ions from the active material surface to the electrode plate surface by adding the oxide Y to the electrode plate.

In a preferred mode of the present invention, the oxide Y has a mean particle size of 0.01 to 0.5 μm. When the mean particle size is less than 0.01 μm, the particles of the oxide Y are likely to coagulate and thus it will be difficult to uniformly disperse the particles of the oxide Y in the material mixture layer. Conversely, the mean particle size exceeding 0.5 μm will also makes it difficult to uniformly disperse the particles of the oxide Y in the material mixture layer, reducing the effect of the transport of lithium ions by virtue of the addition of the oxide Y. As just explained, when the oxide Y has a mean particle size of 0.01 to 0.5 μm, the particles of the oxide Y are uniformly dispersed in the negative electrode material mixture layer so that lithium ions are effectively transported even in the portions containing a smaller amount of the electrolyte. The mean particle size of the oxide Y can be measured by, for instance, laser diffraction scattering (Microtrac HRA particle size analyzer, manufactured by Nikkiso Co., Ltd.). Wherein the mean particle size means a median size based on the number of particles.

The oxide Y is not involved in charge/discharge reaction as stated earlier. Thus, the oxide Y does not release lithium ions electrochemically converted from lithium contained in the oxide Y into the electrode plate or absorb the lithium ions in the electrode plate. Therefore, even when the negative electrode plate contains the oxide Y, the capacity reduction of the electrode plate does not occur because local cells are not set up between the active material and the oxide Y in the electrode plate.

As the lithium-containing oxide Y, at least one selected from the group consisting of LiAlO₂, Li₂TiO₃, Li₂ZrO₃, LiTaO₃, LiNbO₃, LiVO₃, Li₂SiO₃ and Li₄SiO₄ can be used.

The amount of the oxide Y contained in the negative electrode material mixture layer is preferably 0.01 to 1 part by weight relative to 100 parts by weight of the active material. The amount of the oxide Y being greater than 1 part by weight will greatly reduce the packing density of the active material. Conversely, the amount of the oxide Y being less than 0.01 part by weight will result in insufficient dispersion of the oxide Y in the material mixture layer, which reduces the effect of improving the transport of lithium ions.

The negative electrode preferably has a thickness of 0.08 to 0.6 mm. When the electrode plate is thin (i.e. when the negative electrode material mixture layer is thin), the distance that the electrolyte moves in the electrode plate becomes short so that the electrolyte smoothly permeates into the whole electrode plate and thus lithium ions are transported quickly enough. When the thickness of the negative electrode is less than 0.08 mm, however, the effect created by the addition of the oxide Y cannot be achieved. The “thickness of the negative electrode” used herein means the thickness of the whole negative electrode including the material mixture layer and the current collector.

As the thickness of the negative electrode (i.e. the thickness of the negative electrode material mixture layer) is increased, the distance that the electrolyte moves in the electrode plate becomes longer and the electrolyte is unlikely to permeate into the whole electrode plate. The oxide Y contained in the negative electrode serves to improve the transport of lithium ions in the electrode plate so that, even in the case where the electrolyte is not impregnated into the whole electrode plate, uniform dispersion of the oxide Y in the electrode plate allows lithium ions to easily permeate into the electrode plate and thus to reach the active material. The effect of improving the transport of lithium ions by the oxide Y increases with increasing thickness of the electrode plate.

When the electrode plate has a thickness of greater than 0.6 mm, however, the mechanical strength of the electrode plate is reduced. This causes the separation of the material mixture, which may result in impaired reliability and reduced cycle characteristics. Therefore, in the present invention, the thickness of the negative electrode is preferably 0.08 to 0.6 mm.

The thickness of the negative electrode includes the thickness of the current collector and that of the material mixture layer. In the present invention, the thickness of the material mixture layer is preferably 0.03 to 0.29 mm. The effect stated above is prominent particularly when the thickness of the material mixture layer is 0.1 mm or greater. The “thickness of the material mixture layer” used herein means a thickness of the material mixture layer formed on one surface of the electrode plate.

Preferably, the oxide Y has excellent chemical stability to the negative electrode active material and the organic electrolyte, excellent electrochemical and thermal stability in the working voltage range of the battery and low hygroscopicity, and is resistant to hydrolysis. The addition of the oxide Y having such properties will not impair the performance of the electrode plate.

In order to improve the stability of the oxide Y to the organic electrolyte, the dispersibility of the oxide Y during the production of the electrode plate and the affinity between the oxide Y and the binder of the electrode plate, the oxide Y may be subjected to heat treatment at a temperature of not less than 300° C. or to surface treatment such as making the surface thereof hydrophobic or imparting affinity for the organic solvent to the surface thereof by an organic substance.

The addition of the lithium-containing oxide Y with a mean particle size of 0.01 to 0.5 μm to the negative electrode improves the transport of lithium ions from the active material to the surface of the electrode plate even when the electrode plate used is thick and contains the active material in high packing density. This is because, even if some portions of the electrode plate do not contain the electrolyte, the uniform dispersion of the oxide Y in the electrode plate allows lithium ions to be transported to the active material distributed throughout the electrode plate, enabling the active material to be effectively involved in charge/discharge reaction. Accordingly, even when the negative electrode has a higher energy density, cycle characteristics can be improved. Moreover, because the transport of lithium ions is improved, other characteristics such as high rate charge/discharge characteristics and low temperature characteristics can also be improved.

The present invention is specifically described below using examples.

### EXAMPLE 1

Lithium ion secondary batteries as shown in FIG. 1 were produced using various oxides Y listed in Table 1 and evaluated in terms of the utilization rate of the negative electrode active material. The “utilization rate” used herein is the percentage of the discharge capacity at the fifth cycle to the theoretical capacity.

### Production of Battery

(Production of Negative Electrode)

A mixture was prepared by mixing artificial graphite serving as a negative electrode active material with an oxide Y shown in Table 1. The artificial graphite had a mean particle size of 5 μm, and the oxide Y had a mean particle size of 0.1 μm. The amount of the oxide Y added was 0.3 part by weight relative to 100 parts by weight of the active material.

The obtained mixture was mixed with an aqueous dispersion of styrene butadiene resin serving as a binder and an aqueous solution of carboxymethyl cellulose serving as a thickener to give a negative electrode material mixture paste. The active material, the binder and the thickener were mixed in a weight ratio of 97:2:1.

Subsequently, the negative electrode material mixture paste was applied onto both surfaces of a 20 μm-thick current collector made of copper such that the applied paste on the both surfaces had the same thickness, which was then dried to form negative electrode material mixture layers. The current collector with the negative electrode material mixture layers formed on both surfaces thereof was rolled with rollers, which was then dried at 200° C. in a nitrogen atmosphere and stamped with a metal die to give a negative electrode. In this manner, eight negative electrodes were produced and numbered from 1 to 8.

The packing density of the active material of each of the negative electrodes 1 to 8 was calculated from the volume of the material mixture layer and the weight of the active material (i.e. artificial graphite) contained in the material mixture layer. The theoretical capacity was then calculated from the weight of the artificial graphite and the capacity of the artificial graphite (310 mAh/g).

(Production of Positive Electrode)

A mixture of LiCoO₂ serving as a positive electrode active material and acetylene black (AB) serving as a conductive material was mixed with a N-methyl-2-pyrrolidone (NMP) solution containing polyvinylidene fluoride as a binder to give a positive electrode material mixture paste. The active material, the conductive material and the binder were mixed in a weight ratio of 95:2:3.

The obtained positive electrode material mixture paste was applied onto one surface of a 20 μm-thick current collector made of aluminum, which was then dried to form a positive electrode material mixture layer. The current collector with the positive electrode material mixture layer formed on one surface thereof was rolled with rollers, during which the thickness of the positive electrode material mixture was adjusted such that the packing density of the positive electrode material mixture would be about 3.6 g/cm³.

Subsequently, the resultant was dried at 200° C. in a nitrogen atmosphere and stamped with a metal die to give a positive electrode. The theoretical capacity of the positive electrode active material contained in the positive electrode was adjusted to be sufficiently larger than that of the negative electrode active material contained in the negative electrode in order that the capacity of the battery was not restricted by the positive electrode during the cycle test described later.

(Assembly of Battery)

The negative electrode and the positive electrodes produced above were combined with 30 μm-thick porous separators made of polyethylene interposed therebetween to give an electrode assembly. This electrode assembly was housed in a case made of laminated film composed of aluminum and thermoplastic resin. An end formed by combining the ends of the positive electrode current collectors with no material mixture layer formed thereon was drawn to the outside through an opening of the case. Likewise, an end of the negative electrode current collector with no material mixture layer formed thereon was drawn to the outside through another opening of the case.

An electrolyte was prepared by dissolving LiPF₆ in a mixture solvent of ethylene carbonate (EC), diethyl carbonate (DEC) and ethyl methyl carbonate (EMC) at a volume ratio of 2:2:3 at a LiPF₆ concentration of 1.2 mol/L. This electrolyte was injected into the case. Finally, the openings of the case were heat-welded under a reduced pressure for sealing.

In the manner described above, batteries 1 to 8, each having a negative electrode containing different oxide Y specified in Table 1, were assembled. For comparison, a battery with a negative electrode without the oxide Y was produced in the same manner as described above. This was designated as “battery for comparison 1”.

(Evaluation of Utilization Rate)

Each of the produced batteries was repeatedly (5 times) charged and discharged at a rate of 0.2 C (the rate at which the theoretical capacity is charged and discharged in 5 hours) in the range from 4.2 to 3.0 V. The discharge capacity at the fifth cycle was measured. Then, the utilization rate of the negative electrode active material was calculated by multiplying the ratio of the discharge capacity at the fifth cycle to the theoretical capacity of the negative electrode by 100. In the evaluation presented here, the charging/discharging cycle was performed at an ambient temperature of 20° C. The obtained results are shown in Table 1. The thickness of the negative electrode (the thickness of the material mixture layer) and the porosity are also shown in Table 1.

TABLE 1

| | | Thickness of Negative | | |
|---|---|---|---|---|
| | | electrode (Thickness | | |
| | | of Material | | |
| | Oxide | mixture layer) | Porosity | Utilization |
| | Y | (mm) | (%) | rate (%) |
| Battery 1 | LiAlO₂ | 0.123(0.0515) | 30 | 88 |
| Battery 2 | Li₂TiO₃ | 0.120(0.05) | 28 | 86 |
| Battery 3 | Li₂ZrO₃ | 0.125(0.0525) | 27 | 91 |
| Battery 4 | LiTaO₃ | 0.130(0.055) | 26 | 91 |
| Battery 5 | LiNbO₃ | 0.129(0.0545) | 28 | 89 |
| Battery 6 | LiVO₃ | 0.122(0.051) | 29 | 93 |
| Battery 7 | Li₂SiO₃ | 0.120(0.05) | 31 | 94 |
| Battery 8 | Li₄SiO₄ | 0.125(0.0525) | 27 | 90 |
| Battery for | None | 0.120(0.05) | 31 | 64 |
| comparison 1 | | | | |

As seen from Table 1, the batteries 1 to 8, each having a negative electrode containing different oxide Y, had a high utilization rate of not less than 80%, whereas the battery for comparison 1 containing no oxide Y had a low utilization rate of 64%.

### EXAMPLE 2

Batteries 9 to 12 and batteries for comparison 2 to 3 were produced in the same manner as in EXAMPLE 1, except that lithium aluminate (LiAlO₂) was used as the oxide Y and the mean particle size of the oxide Y was varied as shown in Table 2.

The utilization rate for each of the above produced batteries was determined in the same manner as in EXAMPLE 1. The results are shown in Table 2. Table 2 also shows the thickness of the negative electrode (the thickness of the material mixture layer) and the porosity.

TABLE 2

| | Mean | Thickness of | | |
|---|---|---|---|---|
| | particle | Negative electrodes | | |
| | size of | (Thickness of Material | | |
| | Oxide Y | mixture layer) | Porosity | Utilization |
| | (μm) | (mm) | (%) | rate (%) |
| Battery for | 0.005 | 0.123(0.0515) | 30 | 67 |
| comparison 2 | | | | |
| Battery 9 | 0.01 | 0.120(0.05) | 28 | 88 |
| Battery 10 | 0.04 | 0.125(0.0525) | 27 | 91 |
| Battery 11 | 0.2 | 0.130(0.055) | 26 | 91 |
| Battery 12 | 0.5 | 0.129(0.0545) | 28 | 89 |
| Battery for | 0.8 | 0.122(0.051) | 29 | 71 |
| comparison 3 | | | | |

As seen from Table 2, the batteries 9 to 12 containing LiAlO₂ with a mean particle size of 0.01 to 0.5 μm had a utilization rate of not less than 88%, whereas the battery for comparison 2 containing LiAlO₂ with a mean particle size of 0.005 μm and the battery for comparison 3 with LiAlO₂ with a mean particle size of 0.8 μm had a low utilization rate of 67% and 71%, respectively. The negative electrodes of the batteries for comparison 2 and 3 were cut and the cross section thereof was analyzed using a scanning electron microscope (SEM), which revealed that the particles of the oxide Y were coagulated to form secondary particles and they were not uniformly dispersed.

### EXAMPLE 3

Batteries 13 to 17 were produced in the same manner as in EXAMPLE 1, except that LiAlO₂ with a mean particle size of 0.04 μm was used as the oxide Y and the amount of the oxide Y relative to 100 parts by weight of the negative electrode active material was varied as shown in Table 3. For comparison, a battery for comparison 4 with a negative electrode containing no oxide Y was produced.

The utilization rate for each of the above produced batteries was determined in the same manner as in EXAMPLE 1. The results are shown in Table 3. Table 3 also shows the thickness of the negative electrode (the thickness of the material mixture layer) and the porosity.

TABLE 3

| | Amount of | Thickness of | | |
|---|---|---|---|---|
| | Oxide Y | Negative electrode | | |
| | (part | (Thickness of Material | | |
| | by | mixture layer) | Porosity | Utilization |
| | weight) | (mm) | (%) | rate (%) |
| Battery for | None | 0.120(0.05) | 31 | 64 |
| comparison 4 | | | | |
| Battery 13 | 0.005 | 0.120(0.05) | 28 | 75 |
| Battery 14 | 0.01 | 0.125(0.0525) | 27 | 83 |
| Battery 15 | 0.1 | 0.130(0.055) | 26 | 91 |
| Battery 16 | 1 | 0.126(0.053) | 28 | 88 |
| Battery 17 | 3 | 0.130(0.055) | 29 | 74 |

As seen from Table 3, the batteries 13 to 17 had an improved utilization rate compared to the battery for comparison 4. Particularly, the batteries 14 to 16 containing LiAlO₂ in an amount of 0.01 to 1 part by weight relative to 100 parts by weight of the negative electrode active material had a high utilization rate of not less than 83%.

### EXAMPLE 4

Batteries 18 to 24 were produced in the same manner as in EXAMPLE 1, except that LiAlO₂ with a mean particle size of 0.04 μm was added in an amount of 0.3 part by weight relative to 100 parts by weight of the negative electrode active material and the thickness of the negative electrode (the thickness of the material mixture layer) was varied as shown in Table 4.

For comparison, a battery including a negative electrode with a thickness of 0.13 mm (with a material mixture layer thickness of 0.055 mm) containing no LiAlO₂ was produced. This battery was designated as “battery for comparison 5”.

The utilization rate for each of the above produced batteries was determined in the same manner as in EXAMPLE 1. The results are shown in Table 4. Table 4 also shows the porosity of the negative electrode and the discharge capacity at the fifth cycle.

TABLE 4

| | Thickness of | | | |
|---|---|---|---|---|
| | Negative electrode | | | |
| | (Thickness of Material | | Discharge | |
| | mixture layer) | Porosity | capacity | Utilization |
| | (mm) | (%) | (mAh/cm²) | rate (%) |
| Battery 18 | 0.04(0.01) | 28 | 7 | 88 |
| Battery 19 | 0.08(0.03) | 26 | 14 | 95 |
| Battery 20 | 0.13(0.055) | 26 | 22 | 89 |
| Battery 21 | 0.24(0.11) | 27 | 39 | 86 |
| Battery 22 | 0.4(0.19) | 28 | 62 | 82 |
| Battery 23 | 0.6(0.29) | 28 | 91 | 80 |
| Battery 24 | 1.0(0.49) | 30 | 55 | 30 |
| Battery for | 0.13(0.055) | 32 | 21 | 83 |
| comparison | | | | |
| 5 | | | | |

It is well known that, when the oxide Y is not contained, the utilization rate decreases as the thickness of the electrode plate is increased. As seen from Table 4, however, the batteries 19 to 23 had a utilization of not less than 80%.

The battery 24 including a negative electrode with a thickness of 1.0 mm had a low utilization rate of 30% because the mechanical strength of the electrode plate was low and the material mixture layer was likely to be separated and detached.

The battery 18 including a negative electrode with a thickness of 0.04 mm had a utilization rate almost equal to that of the battery for comparison 5 containing no LiAlO₂, which indicates that the effect created by the oxide Y did not appear.

It is clear from the above results that the thickness of the negative electrode is preferably 0.08 to 0.6 mm and the thickness of the material mixture layer is preferably 0.03 to 0.29 mm.

Although not quantified because the mechanical strength was not measured, it appeared that the mechanical strength of the electrode plate of the batteries 19 to 23 decreased as the thickness was increased. However, even the batteries 22 and 23 had a mechanical strength almost equal to that of the battery for comparison 5. This has revealed that the oxide Y serves to improve not only the transport of lithium ions but also the mechanical strength of the electrode plate. Therefore, the addition of the oxide Y to the negative electrode material mixture layer prevents internal short-circuiting in the battery resulting from the separation of the material mixture, leading to the improvement of cycle characteristics and reliability of the lithium ion secondary battery.

### EXAMPLE 5

Batteries 25 to 28 and batteries for comparison 6 to 7 were produced in the same manner as in EXAMPLE 1, except that lithium vanadate (LiVO₃) was used as the oxide Y and the mean particle size of the oxide Y was varied as shown in Table 5.

The utilization rate for each of the above produced batteries was determined in the same manner as in EXAMPLE 1. The obtained results are shown in Table 5. Table 5 also shows the thickness of the negative electrode (the thickness of the material mixture layer) and the porosity.

TABLE 5

| | Mean | Thickness of | | |
|---|---|---|---|---|
| | particle | Negative electrode | | |
| | size | (Thickness of Material | | |
| | of Oxide | mixture layer) | Porosity | Utilization |
| | Y (μm) | (mm) | (%) | rate (%) |
| Battery for | 0.005 | 0.123(0.0515) | 30 | 62 |
| comparison | | | | |
| 6 | | | | |
| Battery 25 | 0.01 | 0.120(0.05) | 28 | 91 |
| Battery 26 | 0.04 | 0.125(0.0525) | 27 | 93 |
| Battery 27 | 0.2 | 0.130(0.055) | 26 | 90 |
| Battery 28 | 0.5 | 0.129(0.0545) | 28 | 85 |
| Battery for | 0.8 | 0.122(0.051) | 29 | 68 |
| comparison | | | | |
| 7 | | | | |

As seen from Table 5, the batteries 25 to 28 containing LiVO₃ with a mean particle size of 0.01 to 0.5 μm had a high utilization rate of not less than 85%, whereas the battery for comparison 6 containing LiVO₃ with a mean particle size of 0.005 μm and the battery for comparison 7 with LiVO₃ with a mean particle size of 0.8 μm had a low utilization rate of 62% and 68%, respectively. The negative electrodes of the batteries for comparison 6 and 7 were cut and the cross section thereof was analyzed using an SEM, which revealed that the particles of the oxide Y were coagulated to form secondary particles and they were not uniformly dispersed.

### EXAMPLE 6

Batteries 29 to 33 and a battery for comparison 8 were produced in the same manner as in EXAMPLE 1, except that LiVO₃ with a mean particle size of 0.04 μm was used as the oxide Y and the amount of the oxide Y relative to 100 parts by weight of the negative electrode active material was varied as shown in Table 6.

The utilization rate for each of the above produced batteries was determined in the same manner as in EXAMPLE 1. The obtained results are shown in Table 6. Table 6 also shows the thickness of the negative electrode (the thickness of the material mixture layer) and the porosity.

TABLE 6

| | Amount | Thickness of | | |
|---|---|---|---|---|
| | of | Negative electrode | | |
| | Oxide Y | (Thickness of Material | | |
| | (part by | mixture layer) | Porosity | Utilization |
| | weight) | (mm) | (%) | rate (%) |
| Battery for | None | 0.120(0.05) | 31 | 64 |
| comparison 8 | | | | |
| Battery 29 | 0.005 | 0.120(0.05) | 28 | 73 |
| Battery 30 | 0.01 | 0.125(0.0525) | 27 | 81 |
| Battery 31 | 0.1 | 0.130(0.055) | 26 | 88 |
| Battery 32 | 1 | 0.126(0.053) | 28 | 85 |
| Battery 33 | 3 | 0.130(0.055) | 29 | 74 |

As seen from Table 6, the batteries 29 to 33 had an improved utilization rate compared to the battery for comparison 8. Particularly, the batteries 30 to 32 containing LiVO₃ in an amount of 0.01 to 1 part by weight relative to 100 parts by weight of the negative electrode active material had a high utilization rate of not less than 81%.

### EXAMPLE 7

Batteries 34 to 40 were produced in the same manner as in EXAMPLE 1, except that LiVO₃ with a mean particle size of 0.04 μm was added in an amount of 0.3 part by weight relative to 100 parts by weight of the negative electrode active material and the thickness of the negative electrode (the thickness of the material mixture layer) was varied as shown in Table 7. For comparison, a battery including a negative electrode with a thickness of 0.13 mm (with a material mixture layer thickness of 0.055 mm) containing no LiVO₃ was produced. The resultant battery was designated as “battery for comparison 9”.

The utilization rate for each of the above produced batteries was determined in the same manner as in EXAMPLE 1. The results are shown in Table 7. Table 7 also shows the porosity of the negative electrode and the discharge capacity.

TABLE 7

| | Thickness of | | | |
|---|---|---|---|---|
| | Negative electrode | | | |
| | (Thickness of | | | |
| | Material mixture | | Discharge | |
| | layer) | Porosity | capacity | Utilization |
| | (mm) | (%) | (mAh/cm²) | rate (%) |
| Battery 34 | 0.03(0.005) | 28 | 7 | 89 |
| Battery 35 | 0.08(0.03) | 26 | 14 | 90 |
| Battery 36 | 0.12(0.05) | 26 | 22 | 91 |
| Battery 37 | 0.26(0.12) | 27 | 39 | 88 |
| Battery 38 | 0.37(0.175) | 28 | 62 | 87 |
| Battery 39 | 0.6(0.29) | 28 | 91 | 80 |
| Battery 40 | 1.0(0.49) | 30 | 55 | 30 |
| Battery for | 0.13(0.055) | 32 | 21 | 83 |
| comparison 9 | | | | |

As seen from Table 7, the batteries 35 to 39 had a utilization rate of not less than 80%.

The battery 40 including a negative electrode with a thickness of 1.0 mm had a low utilization rate of 30% because the mechanical strength of the electrode plate was low and the material mixture layer was likely to be separated and detached.

The battery 34 including a negative electrode with a thickness of 0.03 mm had a utilization rate almost equal to that of the battery for comparison 9 containing no LiVO₃, which indicates that the effect created by the oxide Y did not appear.

It is clear from the above results that the thickness of the negative electrode is preferably 0.08 to 0.6 mm and the thickness of the material mixture layer is preferably 0.03 to 0.29 mm.

Although not quantified because the mechanical strength was not measured, it appeared that the mechanical strength of the electrode plate of the batteries 35 to 39 decreased as the thickness was increased. However, even the batteries 38 and 39 had a mechanical strength almost equal to that of the battery for comparison 9. This has revealed that the oxide Y serves to improve not only the transport of lithium ions but also the mechanical strength of the electrode plate. Therefore, the addition of the oxide Y to the negative electrode material mixture layer prevents internal short-circuiting in the battery resulting from the separation of the material mixture, leading to the improvement of cycle characteristics and reliability of the lithium ion secondary battery.

### EXAMPLE 8

Particulate nickel and particulate silicon were placed in an alumina crucible at a ratio of 20.4 atom % to 79.6 atom %, which was heated to 1250° C. in an argon atmosphere in an electric furnace. The temperature was maintained for 1 hour, and then the melt product was cooled to room temperature in the electric furnace. The obtained ingot was ground using a planetary ball mill, which was then sized to give a powdered silicon alloy with a mean particle size of 1 μm.

The obtained powdered silicon alloy serving as a negative electrode active material was mixed with an oxide Y specified in Table 8 such that the amount of the oxide Y would be 0.3 part by weight relative to 100 parts by weight of the negative electrode active material.

This mixture was mixed with polyvinylidene fluoride resin as a binder and artificial graphite with a mean particle size of 5 μm as a conductive material in a weight ratio of 75:20:5, which was then dispersed in dehydrated N-methyl-2-pyrrolidinone to give a negative electrode active material paste. Batteries were produced in the same manner as in EXAMPLE 1 except that a negative electrode active material paste prepared in the above manner was used. The produced batteries were numbered from 41 to 48. For comparison, a battery containing no oxide Y was produced. This was designated as “battery for comparison 10”.

The utilization rate for each of the above produced batteries was determined in the same manner as in EXAMPLE 1. The obtained results are shown in Table 8. Table 8 also shows the thickness of the negative electrode (the thickness of the material mixture layer) and the porosity.

The theoretical capacity of the negative electrode for each of the batteries 41 to 48 and the battery for comparison 10 was calculated on the assumption that Si obtained by subtracting Si contained in NiSi₂ from Si contained in the alloy was involved in the charge/discharge. As a result, the theoretical capacity of the negative electrode was 4200 mAh/g.

TABLE 8

| | | Thickness of | | |
|---|---|---|---|---|
| | | Negative electrode | | |
| | | (Thickness of Material | | |
| | | mixture layer) | Porosity | Utilization |
| | Oxide Y | (mm) | (%) | rate (%) |
| Battery 41 | LiAlO₂ | 0.123(0.055) | 30 | 85 |
| Battery 42 | Li₂TiO₃ | 0.120(0.05) | 28 | 83 |
| Battery 43 | Li₂ZrO₃ | 0.125(0.0525) | 27 | 88 |
| Battery 44 | LiTaO₃ | 0.130(0.055) | 26 | 85 |
| Battery 45 | LiNbO₃ | 0.129(0.0545) | 28 | 83 |
| Battery 46 | LiVO₃ | 0.122(0.051) | 29 | 85 |
| Battery 47 | Li₂SiO₃ | 0.120(0.05) | 31 | 94 |
| Battery 48 | Li₄SiO₄ | 0.125(0.0525) 27 | 87 | |
| Battery for | None | 0.120(0.05) | 31 | 75 |
| comparison 10 | | | | |

As seen in Table 8, even when the negative electrode active material was composed of a silicon alloy, the batteries 41 to 48 containing the oxide Y had a high utilization rate of not less than 83%. The battery for comparison 10 containing no oxide Y, on the other hand, had a low utilization rate of 75%.

### EXAMPLE 9

Batteries 49 to 52 and batteries for comparison 11 to 12 were produced in the same manner as in EXAMPLE 8, except that lithium silicate (Li₄SiO₄) was used as the oxide Y and the mean particle size of the oxide Y was varied as shown in Table 9.

The utilization rate for each of the above produced batteries was determined in the same manner as in EXAMPLE 1. The obtained results are shown in Table 9. Table 9 also shows the thickness of the negative electrode (the thickness of the material mixture layer) and the porosity.

TABLE 9

| | Mean | Thickness of | | |
|---|---|---|---|---|
| | particle | Negative electrode | | |
| | size of | (Thickness of Material | | |
| | Oxide | mixture layer) | PorosityZ | Utilization |
| | Y (μm) | (mm) | (%) | rate (%) |
| Battery for | 0.005 | 0.123(0.0515) | 30 | 60 |
| comparison 11 | | | | |
| Battery 49 | 0.01 | 0.120(0.05) | 28 | 85 |
| Battery 50 | 0.04 | 0.125(0.0525) | 27 | 88 |
| Battery 51 | 0.2 | 0.130(0.055) | 26 | 87 |
| Battery 52 | 0.5 | 0.129(0.0545) | 28 | 83 |
| Battery for | 0.8 | 0.122(0.051) | 29 | 68 |
| comparison 12 | | | | |

As seen from Table 9, the batteries 49 to 52 containing Li₄SiO₄ with a mean particle size of 0.01 to 0.5 μm had a utilization rate of not less than 83%, whereas the battery for comparison 11 containing Li₄SiO₄ with a mean particle size of 0.005 μm and the battery for comparison 12 containing Li₄SiO₄ with a mean particle size of 0.8 μm had a low utilization rate of 60% and 68%, respectively. The negative electrodes of the batteries for comparison 11 and 12 were cut and the cross section thereof was analyzed using an SEM, which revealed that the particles of the oxide Y were coagulated to form secondary particles and they were not uniformly dispersed.

### EXAMPLE 10

Batteries 53 to 57 and a battery for comparison 13 were produced in the same manner as in EXAMPLE 8, except that Li₄SiO₄ with a mean particle size of 0.04 μm was used as the oxide Y and the amount of the oxide Y relative to 100 parts by weight of the negative electrode active material was varied as shown in Table 10.

The utilization rate for each of the above produced batteries was determined in the same manner as in EXAMPLE 1. The obtained results are shown in Table 10. Table 10 also shows the thickness of the negative electrode (the thickness of the material mixture layer) and the porosity.

TABLE 10

| | Amount | Thickness of | | |
|---|---|---|---|---|
| | of | Negative electrode | | |
| | Oxide | (Thickness of Material | | |
| | Y (part | mixture layer) | Porosity | Utilization |
| | by weight) | (mm) | (%) | rate (%) |
| Battery for | None | 0.120(0.05) | 31 | 60 |
| comparison 13 | | | | |
| Battery 53 | 0.005 | 0.120(0.05) | 28 | 73 |
| Battery 54 | 0.01 | 0.125(0.0525) | 27 | 81 |
| Battery 55 | 0.1 | 0.130(0.055) | 26 | 88 |
| Battery 56 | 1 | 0.126(0.053) | 28 | 82 |
| Battery 57 | 3 | 0.130(0.055) | 29 | 70 |

As seen from Table 10, the batteries 53 to 57 had an improved utilization rate compared to the battery for comparison 13. Particularly, the batteries 54 to 56 containing Li₄SiO₄ in an amount of 0.01 to 1 part by weight relative to 100 parts by weight of the negative electrode active material had a high utilization rate of not less than 81%. This was the same result as those obtained in EXAMPLEs 3 and 6 described above.

### EXAMPLE 11

Batteries 58 to 64 were produced in the same manner as in EXAMPLE 8, except that Li₄SiO₄ with a mean particle size of 0.04 μm was added in an amount of 0.3 part by weight relative to 100 parts by weight of the negative electrode active material and the thickness of the negative electrode (the thickness of the material mixture layer) was varied as shown in Table 11. For comparison, a battery including a negative electrode with a thickness of 0.13 μm (with a material mixture layer thickness of 0.055 mm) containing no Li₄SiO₄ was produced. This battery was designated as “battery for comparison 14”.

The utilization rate for each of the above produced batteries was determined in the same manner as in EXAMPLE 1. The results are shown in Table 11. Table 11 also shows the porosity of the negative electrode and the discharge capacity.

TABLE 11

| | Thickness of | | Discharge | |
|---|---|---|---|---|
| | Negative electrode | | capacity | |
| | (Thickness of Material | Porosity | (mAh/ | Utilization |
| | mixture layer) (mm) | (%) | cm²⁾ | rate (%) |
| Battery 58 | 0.04(0.01) | 28 | 7 | 85 |
| Battery 59 | 0.08(0.03) | 26 | 14 | 88 |
| Battery 60 | 0.13(0.055) | 26 | 22 | 87 |
| Battery 61 | 0.24(0.11) | 27 | 39 | 85 |
| Battery 62 | 0.4(0.18) | 28 | 62 | 84 |
| Battery 63 | 0.6(0.29) | 28 | 91 | 80 |
| Battery 64 | 1.0(0.49) | 30 | 55 | 25 |
| Battery for | 0.13(0.055) | 32 | 21 | 80 |
| comparison 14 | | | | |

As seen from Table 11, the batteries 59 to 63 had a utilization rate of not less than 80%. The battery 64 including a negative electrode with a thickness of 1.0 mm had a low utilization rate of 25% because the mechanical strength of the electrode plate was low and the material mixture layer was likely to be separated and detached.

The battery 58 including a negative electrode with a thickness of 0.04 mm had a utilization rate almost equal to that of the battery for comparison 14 containing no Li₄SiO₄, which indicates that the effect created by the oxide Y did not appear.

It is clear from the above results that the thickness of the negative electrode is preferably 0.08 to 0.6 mm and the thickness of the material mixture layer is preferably 0.03 to 0.29 mm. This was the same result as those obtained in EXAMPLEs 4 and 7.

Although not quantified because the mechanical strength was not measured, it appeared that the mechanical strength of the electrode plate of the batteries 59 to 63 decreased as the thickness was increased. However, even the batteries 62 and 63 had a mechanical strength almost equal to that of the battery for comparison 14. This has revealed that the oxide Y serves to improve not only the transport of lithium ions but also the mechanical strength of the electrode plate. Therefore, the addition of the oxide Y to the negative electrode material mixture layer prevents internal short-circuiting in the battery resulting from the separation of the material mixture, leading to the improvement of cycle characteristics and reliability of the lithium ion secondary battery.

The above EXAMPLEs 1 to 11 utilized LiCoO₂ as the positive electrode active material, and artificial graphite or a silicon alloy (composite particle comprising Si coated with NiSi₂) as the negative electrode active material, but the same effect can be achieved by using positive and negative electrode active materials other than LiCoO₂ for the positive electrode active material and the artificial graphite and the silicon alloy for the negative electrode active material used in examples. Other examples of the positive electrode active material include LiNiO₂, Li₂MnO₄, LiMnO₂ and LiV₃O₈. They can be used singly or in any combination thereof. Other examples of the negative electrode active material include carbonaceous materials such as natural graphite and graphitized carbon fiber, Si, Sn, Al, B, Ge, P, Pb, any mixed alloy thereof and oxides thereof, and nitrides such as Li₃N and Li₃₋ₓCoₓN.

As for the binder, a material stable in the organic electrolyte can be used other than those used in EXAMPLEs of the present invention.

Likewise, any combination of a solute and an organic solvent typically used in lithium ion secondary batteries can be selected for the electrolyte. Such electrolyte can be used also when the separator is made of a lithium ion conductive gel.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising:
(1) a positive electrode containing a positive electrode active material composed of a lithium-containing composite oxide X;
(2) a negative electrode containing a negative electrode active material composed of a material capable of absorbing and desorbing lithium ions and a lithium-containing oxide Y not involved in charge/discharge reaction;
(3) an organic electrolyte; and
(4) a separator placed between said positive electrode and said negative electrode,
wherein said lithium-containing composite oxide X and said lithium-containing oxide Y are different materials and said lithium-containing oxide Y has a mean particle size of 0.01 to 0.5 μm.

2. The lithium ion secondary battery in accordance with claim 1, wherein said lithium-containing oxide Y is contained in said negative electrode in an amount of 0.01 to 1 part by weight relative to 100 parts by weight of the negative electrode active material.

3. The lithium ion secondary battery in accordance with claim 1, wherein, when said negative electrode comprises a current collector and a material mixture layer formed on said current collector, said negative electrode material mixture layer has a thickness of 0.03 to 0.29 mm.

4. The lithium ion secondary battery in accordance with claim 1, wherein said lithium-containing oxide Y comprises at least one selected from the group consisting of LiAlO₂, Li₂TiO₃, Li₂ZrO₃, LiTaO₃, LiNbO₃, LiVO₃, Li₂SiO₃ and Li₄SiO₄.
